(19) United States
(12) Patent Application Publication
(10) Pub. No.: US 2013/0310492 A1
(43) Pub. Date: Nov. 21, 2013

(54) PROCESS FOR IMPROVING THE PHYSICAL PROPERTIES OF BITUMEN

(71) Applicant: BAKER HUGHES INCORPORATED, (US)

(72) Inventors: Ben Morgan, Sugar Land, TX (US); Joseph L. Stark, Richmond, TX (US); Jennifer D. Draper, Houston, TX (US)

(73) Assignee: BAKER HUGHES INCORPORATED, HOUSTON, TX (US)

(21) Appl. No.: 13/673,248

(22) Filed: Nov. 9, 2012

Related U.S. Application Data
(60) Provisional application No. 61/561,034, filed on Nov. 17, 2011.
(60) Provisional application No. 61/562,286, filed on Nov. 21, 2011.

(51) Int. Cl. C08L 95/00

(52) U.S. Cl. CPC C08L 95/00
USPC 524/59

(57) ABSTRACT

Additives may be used to improve certain physical properties of bitumen. The additives are prepared using a formulation comprising: a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof; and a second component which is a synergist and selected from the group consisting of polyamines, amidoamines, imidazolines, and combinations thereof.

### CROSS-SECTION TO RELATED APPLICATIONS

This applications claims priority from U.S. Provisional patent application Ser. No. 61/561,034, filed Nov. 17, 2011 and U.S. Provisional patent application Ser. No. 61/562,286 filed Nov. 21, 2011, the disclosures of which are incorporated herein by reference in its entirety.

### BACKGROUND OF THE APPLICATION

1. Field of the Invention

This invention relates to manufacturing and using bitumen and asphalt.

2. Background of the Prior Art

Heavy hydrocarbons such as bitumen, kerogen, and tars are high molecular weight hydrocarbons frequently encountered in subterranean formations. These hydrocarbons range from thick viscous liquids to solids at ambient temperatures and are generally quite expensive to recover in useful form. Bitumen occurs naturally in tar sands in locations such as Alberta, Canada and in the Orinoco oil belt north of the Orinoco river in Venezuela. Kerogens are the precursors to fossil fuels, and are also the material that forms oil shales.

When produced directly from geological formations, they are generally quite expensive to recover in useful form. For example, bitumen occurs naturally in tar sands in locations such as Alberta, Canada and in the Orinoco oil belt north of the Orinoco river in Venezuela. Kerogens are the precursors to fossil fuels, and are also the material that forms oil shales. Kerogens are frequently found in sedimentary rock formations. Asphalts or bitumen is also the term applied to the very heavy hydrocarbons resulting from crude oil refining steps such as cracking and coking.

Bitumen is a long lasting material, even in severe environments, and can almost always be recycled. Sources of recycled bitumen include, but are not limited to, road asphalt, automobile tires, roofing shingles, and roofing membranes. In recycling bitumen, it is often desirable to mix a recycled bitumen stream with a virgin bitumen stream. Sometimes, a heavy hydrocarbon but not necessarily an asphalt or bitumen may be used to mix with the recycle stream.

Heavy hydrocarbons in general and bitumens in particular, are a potentially valuable feedstock for generating lighter hydrocarbons. Unfortunately, these bitumen streams are not always compatible which can lead to premature failure of the bitumen product produced therewith. It is difficult to predict which bitumen mixtures are compatible and which are not so it would be desirable in the art to be able to reliably determine the stability of bitumen product streams prior to using those streams to manufacture products such as road paving materials.

### SUMMARY OF THE INVENTION

In one aspect, the invention is a process for modifying bitumen including admixing unmodified bitumen with an additive to produce a modified bitumen wherein the modified bitumen has a physical property change, as compared to the unmodified bitumen and the physical property is selected from the group consisting of:

a set up point that is at least 2° C. lower than the unmodified bitumen;
an asphaltene stability that is improved such that asphaltenes are more resistant to precipitation during asphalt blending, gasoil blending, vacuum gasoil blending, storage and transport as compared to an unmodified bitumen;
an improved resistance to oxidative aging;
a more stable viscosity;
an improved adhesive strength of wherein the modified bitumen has an adhesive strength that is at least 10 percent greater than unmodified bitumen; and combinations thereof;
wherein the additive is prepared from a formulation comprising:
a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof; and
a second component which is a synergist and selected from the group consisting of polyamines, amidoamines, imidazolines, and combinations thereof.

In another aspect, the invention is a method of preparing bitumen comprising mixing at least two bitumen feed streams to prepare a bitumen product stream; analyzing the feed streams and the product stream to determine a stability index for each using a Bitumen Asphaltene Stability Index Test; and when the index value for the bitumen product stream is less than about 90% of the weighted average index value for the feed streams, modifying the product stream to achieve a stability index value that is at least 90% of the weighted average index value for the feed streams.

In another aspect, the invention is a method of preparing bitumen comprising modeling a bitumen production process by admixing samples of at least two bitumen feed streams to produce a model bitumen production stream; analyzing the feed streams and the product stream to determine a stability index for each using a Bitumen Asphaltene Stability Index Test; and when the index value for the bitumen product stream is less than about 90% of the weighted average index value for the feed streams, repeat the process using different feed mix ratios and/or bitumen stability additives until a stable bitumen product stream model is produced; and then using the model to control the bitumen production process.

### BRIEF DESCRIPTION OF THE DRAWING

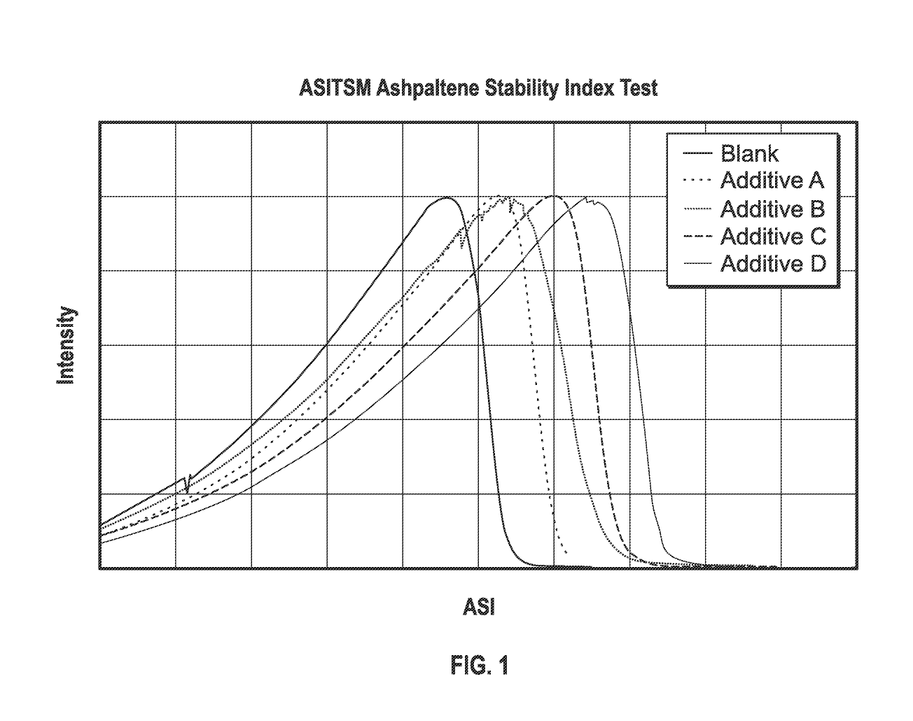

The above and other features and advantages of the present invention will become more apparent by describing in detail embodiments thereof with reference to the attached drawing in which FIG. 1 is a chart showing ASITSM Stability for additives A-D.

### DETAILED DESCRIPTION OF THE INVENTION

In one aspect, the invention is a process for modifying bitumen including admixing unmodified bitumen with an additive to produce a modified bitumen wherein the modified bitumen has a physical property change, as compared to the unmodified bitumen. The physical property may be selected from the group consisting of: a set up point that is at least 2° C. lower than the unmodified bitumen; an asphaltene stability that is improved such that asphaltenes are more resistant to precipitation during asphalt blending, gasoil blending, vacuum gasoil blending, storage and transport as compared to an unmodified bitumen; an improved resistance to oxidative aging; a more stable viscosity; an improved adhesive strength of wherein the modified bitumen has an adhesive strength that is at least 10 percent greater than unmodified bitumen; and combinations thereof.

The additive is prepared from a formulation including: a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof. The formulation also includes a second component which is a synergist and selected from the group consisting of polyamines, amidoamines, imidazolines, and combinations thereof.

For the purposes of the present application, the term bitumen means not only bitumen, but also kerogens, tars and other high molecular weight hydrocarbons that are solid or highly viscous at ambient temperatures. For example, bitumen and coke are often the last stops for crude oil in a refinery process. Typically, bitumen and coke are the least valuable of the products produced from crude oil. Bitumen is also sometimes referred to as asphalt.

It follows then that it is often desirable to produce as much lower molecular weight hydrocarbon from crude oil as possible. One problem in doing so is that resid crude oil increases in viscosity as the resid crude oil is subject to more and more extractions of lower molecular weight hydrocarbons. If too much lower molecular weight hydrocarbons are removed from crude oil resid, then it may become a bitumen or coke at a point in the process where the process cannot further transport the bitumen or coke to a process point that is capable of handling solids and highly viscous hydrocarbons. When this occurs, then expensive and time consuming efforts may have to be employed. For example, it may be necessary to add back lower molecular weight hydrocarbons as a solvent or employ mechanical or hydraulic method of cleaning out the unit occluded with bitumen or coke.

Problems with transporting bitumen do not just occur during a refining process. Bitumen is used in applications where it is admixed with polymers to prepare roofing materials and paving materials. If bitumen is allowed to get too cool, typically near its set up point, it must be reheated or it has to be handled as a solid. This can be undesirable.

For example, in one application of bitumen, bitumen may be sprayed onto a surface using a truck especially equipped for this purpose. U.S. Pat. No. 3,662,953 to Wiens, which is fully incorporated herein by reference, discloses a tank truck with heater and spray bar that is equipped with valve manifolds and valves and a flush tank and external coupling connections and has a master control with valve actuating means which are preferably operated in desired bitumen circuit combinations by fluid pressure to perform a variety of operations other than merely spraying bitumen through the spray bar onto a highway. It is further disclosed that the manifold can be warmed to prevent the bitumen from congealing therein by pumping bitumen from the heated tank back to the heated tank without admitting any of such bitumen to the spray bar.

In one embodiment, a method of the disclosure is a process for modifying bitumen comprising admixing unmodified bitumen with an additive wherein the modified bitumen has a set up point that is at least 2° C. lower than the unmodified bitumen.

In another embodiment, the modified bitumen of the application may have more stable asphaltene properties than an unmodified bitumen. Improved asphaltene stability is evidenced by a modified bitumen that is more resistant to precipitation during asphalt blending, gasoil blending, vacuum gasoil blending, storage and transport as compared to an unmodified bitumen.

Bitumen is often obtained from vacuum tower bottoms or from visbreakers and then often combined with lighter streams such are gas oil to reduce the viscosity and improve handling properties. The asphaltenes is such bitumen can be unstable in themselves or may become unstable when blended with other streams such as gas oil or other bitumen. Unstable asphaltenes can lead to premature aging of the asphalt when it is applied as a final product, either as a pavement or in the roofing industry. The additives of the application may function to increase the stability of the bitumen by stabilizing the asphaltenes. In such embodiments, the additives are often employed at a concentration of from about 0.1 to about 10 wt %.

Asphalt or bitumen can be easily oxidized. For example, it can be oxidized in as little as 4 hours by mixing the asphalt with air and heating to between about 179° C. and about 260° C. The additives of the application can, in some embodiments, reduce such oxidation. Such a reduction may be measured in any way known to be useful to those of ordinary skill in the art. For example, oxygen uptake rates may be measures inside of pressurized vessels. Another example would be to measure changes in the acid number of the bitumen. Still other tests include, but are not limited to RTFOT (Rolling Thin Film Oven Test) and PAV (Pressure Aging Vessel).

When employed in applications such as road paving, it may be important that bitumen have a good adhesion to the inorganic matrix used to extend the bitumen. This characteristic is sometimes referred to in the art as “anti-strip.” For example, in some such applications, the adhesion between modified bitumen and gravel may be improved by at least 10 percent. In other embodiments, the adhesion may be increased by as much as 90% as compared to unmodified bitumen.

The ability of anti-strip additives to improve adhesion is often transitory in conventional additives and becomes ineffective upon storage. In at least some embodiments of the method of the application, the additives of the application may be effective for a much longer time. In some embodiments, particularly those including both an alkyl phenol resin and an imidazoline, an improvement may be seen for a week or longer.

The viscosity of the bitumen itself may, in some embodiments of the method of the application, be made more stable. As recovered from a refining process, at least some lots of bitumen may continue to have internal reactions that increase the viscosity of the bitumen. Some of this may be due to instable asphaltenes as discussed above, but asphaltenes are not the only compounds in bitumen that may continue to grow in viscosity. In some embodiments of the method of the application, the additives may be employed to stop or at least mitigate viscosity growth thereby preventing handling problems with aged bitumen.

In one aspect, the invention is a is a method of preparing bitumen comprising mixing at least two bitumen feed streams to prepare a bitumen product stream; analyzing the feed streams and the product stream to determine a stability index for each using a Bitumen Asphaltene Stability Index Test; and when the index value for the bitumen product stream is less than about 90% of the weighted average index value for the feed streams, modifying the product stream to achieve a stability index value that is at least 90% of the weighted average index value for the feed streams. The Bitumen Asphaltene Stability Index Test is performed by employing a near IR (NIR) laser to detect the onset of asphaltene flocculation and precipitation for bitumen. It determines how stable the asphaltenes are in the bitumen. The bitumen sample is heated and allowed to equilibrate. A non-solvent, such as the viscosity reducing agent n-butane is added, and the near laser transmittance is monitored. When asphaltenes begin to floc, laser transmittance will decrease. The transmittance is plotted vs. volume of non-solvent added, and therefore it is a relative measure of the point of flocculation.

In the practice of the method of the disclosure, at least two bitumen feed streams are admixed. While both of the feed streams may be a virgin bitumen, typically at least one of the bitumen feed streams may be a bitumen recycle stream. A bitumen recycle stream may be selected from the group consisting of recycled asphalt recovered from roads or parking lots, recycled roofing shingles, recycle roofing membranes, and combinations thereof. This process stream has, in most embodiments, been melted and treated to remove fillers and other compositions such as gravel.

In some embodiments, a bitumen feed stream may not even consist of bitumen. For example, a refinery may elect to use a heavy hydrocarbon that is not quite a bitumen as a diluent for an exceptionally heavy bitumen. In most embodiments though, the bitumen feed streams will be a recycle bitumen feed stream and a virgin bitumen feed stream.

In the practice of certain embodiments of the methods of the disclosure, the feed streams will be admixed to form a product stream. Any method of performing this function may be employed. For example, the feed streams may be introduced into a tank and agitated. In an alternative embodiment, the feed streams may be co-injected into a line having static mixers in place. In still another embodiment, the both methods may be employed to mix bitumen feed streams to prepare a bitumen product stream.

In the practice of the methods of the disclosure, each feed stream and a resulting product stream is analyzed using the Bitumen Asphaltene Stability Index Test (BASIT) to determine an asphaltene stability index (ASI) value. The index values for the feed stream are then averaged weighted upon their proportion. For example, if there are only two feed streams and they are of the same volume, then the index values for each stream are then merely averaged. If the two streams were being used in a ratio of 2:1, then the index values would then also be weighted 2:1.

Once the average value for the feed streams is determined, it is then compared to the value for the bitumen product stream. There are three possibilities. One possibility is that average values are HIGHER than that of the products stream. If the product stream has an ASI that is less than about 90% that of the average ASI for the feed streams, then it is likely that the product stream will be unstable and remedial efforts should be taken.

The other two possibilities are that the product steam ASI is equal to or greater than the average feed stream ASI. In these instances, the product stream will have a high probability of being stable.

In those embodiments of the method of the disclosure where the product stream has a too low ASI, then remedial efforts may be employed. At least one such remedial effort may be to use a stabilizing additive to produce a modified bitumen wherein the modified bitumen has a physical property change, as compared to the unmodified bitumen. The physical property may be selected from the group consisting of: a set up point that is at least 2° C. lower than the unmodified bitumen; an asphaltene stability that is improved such that asphaltenes are more resistant to precipitation during asphalt blending, gasoil blending, vacuum gasoil blending, storage and transport as compared to an unmodified bitumen; an improved resistance to oxidative aging; a more stable viscosity; an improved adhesive strength of wherein the modified bitumen has an adhesive strength that is at least 10 percent greater than unmodified bitumen; and combinations thereof.

For the purposes of the application, the term unstable when used regarding bitumen means that the subject bitumen has undesirable properties generally not apparent immediately after being prepared, but that develop over time both during and after storage. Bitumen is often obtained from vacuum tower bottoms or from visbreakers and then often combined with lighter streams such are gas oil to reduce the viscosity and improve handling properties. The asphaltenes in such bitumen can be unstable in themselves or may become unstable when blended with other streams such as gas oil or other bitumen. Unstable asphaltenes can lead to premature aging of the asphalt when it is applied as a final product, either as a pavement or in the roofing industry. The additives of the application may function to increase the stability of the bitumen by stabilizing the asphaltenes. In such embodiments, the additives are often employed at a concentration of from bout 0.1 to about 10 wt %.

Asphalt or bitumen can be easily oxidized. For example, it can be oxidized in as little as 4 hours by mixing the asphalt with air and heating to between about 179° C. and about 260° C. The additives can, in some embodiments, reduce such oxidation. Such a reduction may be measured in any way known to be useful to those of ordinary skill in the art. For example, oxygen uptake rates may be measures inside of pressurized vessels. Another example would be to measure changes in the acid number of the bitumen. Still other tests include, but are not limited to RTFOT (Rolling Thin Film Oven Test) and PAV (Pressure Aging Vessel).

When employed in applications such as road paving, it is important that bitumen have a good adhesion to the inorganic matrix used to extend the bitumen. For example, in some such applications, the adhesion between modified bitumen and gravel may be improved by at least 10 percent. In other embodiments, the adhesion may be increased by as much as 90% as compared to unmodified bitumen.

The viscosity of the bitumen itself may, in some embodiments of the method of the application, be made more stable. As recovered from a refining process, at least some lots of bitumen may continue to have internal reactions that increase the viscosity of the bitumen. Some of this may be due to instable asphaltenes as discussed above, but asphaltenes are not the only compounds in bitumen that may continue to grow in viscosity. In some embodiments of the method of the application, the additives may be employed to stop or at least mitigate viscosity growth thereby preventing handling problems with aged bitumen.

In some embodiments, the additive is prepared from a formulation comprising: a first component selected from the group consisting of (alkoxylated)-(di or tri)-alkyl phenol-aldehyde (amine) resins; α-olefin-maleic anhydride co-polymers and grafted polymers including half ester/amide and full ester/amide derivatives; and combinations thereof; and a second component which is a synergist and selected from the group consisting of polyamines, amidoamines, imidazolines, and combinations thereof. Alkylphenol-formaldehyde resins are typically prepared by the acid or base catalyzed condensation of an alkylphenol with formaldehyde. Alkyl groups are straight or branched and contain about 3 to about 18, preferably about 4 to about 12 carbon atoms. Representative acid catalysts include dodecylbenzenesulfonic acid (DDBSA), toluene sulfonic acid, boron trifluoride, oxalic acid, and the like. Representative base catalysts include potassium hydroxide, sodium methoxide, sodium hydroxide, and the like. In an embodiment, the alkylphenol-formaldehyde resins have a molecular weight (Mn) of about 1,000 to about 50,000. In another embodiment, the alkylphenol-formaldehyde resins have a molecular weight of about 1,000 to about 10,000.

Alkylphenol-formaldehyde resins may be oxyalkylated by contacting the alkylphenol-formaldehyde resins with an epoxide such as ethylene oxide in the presence of a basic catalyst. For example, such resins may be prepared using sodium hydroxide or potassium hydroxide. The molar ratio of epoxide to OH group on the resin may be from about 1 to about 50. In some embodiments, the molar ratio is from about 2 to about 8. In still other embodiments, the molar ratio is from about 3 to about 7. The alkylphenol formaldehyde resins and oxyalkylated alkylphenol formaldehyde resins may be prepared using any method known to be useful to those of ordinary skill in the art of preparing such resins.

The resins may be prepared with ethylene oxide and/or propylene oxide. The alkyl groups may have from about 1 to about 30 carbons. Phenols useful include, but are not limited to phenol, cresol and resorcinol. Aldehydes include but are not limited to formaldehyde, acetaldehyde, propylaldehyde, and butyraldehyde and mixtures thereof. Amines, useful for Mannich resins may be selected from the any amine, but in some embodiments they may be selected from the group consisting of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

When the additive includes an α-olefin-maleic anhydride co-polymer and/or grafted polymer including half ester/amide and full ester/amide derivatives, they may be prepared admixing the monomers and using a catalyst or even heat to polymerize the monomers. Catalysts useful wither the method of the disclosure include, but are not limited to free radical initiator, organic peroxides, chromium catalysts, Ziegler-Natta catalysts and metallocene catalysts.

The additives useful with some embodiments of the invention may include other organic compounds and organic solvents. Organic compounds useful with some embodiments of the additives include, but are not limited to amines and esters. For example, a method of the invention may be practiced using additives including triethyl tetra-amine, tributyl tetra-amine, ethylene diamine, tetraethyl penta-amine, ethyl acetate, propyl acetate, ethyl butyrate, and the like and combinations thereof.

The synergists include polyamines, amidoamines, imidazolines, and combinations thereof. When the synergist is a polyamine, in some embodiments is may be selected from polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof. The synergists may also be the quaternary ammonium salts of these compounds.

When the synergist is an amidoamines, in some embodiments, it may be a tall oil fatty acid amide prepared using one of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof. The synergists may also be the quaternary ammonium salts of these compounds.

When the synergist is an imidazoline, it may be prepared using a tall oil fatty acid-amidoamine and a polyamine as detailed above. It may be further substituted by forming alkyl esters, phosphate esters, thiophosphate esters, Tetra-propenyl succinic anhydride (TPSA), dodecylsuccinic anhydride, amides/esters alkylphosphate esters, arylphosphate esters along the backbone. The synergists may also be the quaternary ammonium salts of these compounds.

In employing the additives of the disclosure, their concentration in bitumen/asphalt in some application may be from about 0.1 to about 10% by weight. In other embodiments, the concentration may be from about 0.1 to about 0.5 weight %.

The organic solvents useful with some embodiments of the invention may include but are not limited to: ethyl benzene, xylene, toluene, and the like. When a solvent is present in the additive, it may be present at a concentration of from about 5 w/v percent to about 95 w/v percent. In other embodiments, the solvent if present at all is present at a concentration of from about 10 to 90 percent. In still other embodiments, the solvent may be present at a concentration of from about 15 to about 85 percent.

The additives disclosed herein may be used in any amount useful in lowering the set up point of a modified bitumen at least 2 degrees centigrade (2° C.) as compared to the same but unmodified bitumen. Set up point determinations may be made using any method known to those of ordinary skill in testing bitumen. For example, one such method that may be used includes stirring bitumen with a stir rod and noting the temperature wherein the stir rod becomes fixed and cannot be moved. Instrumental methods employing differential scanning calorimeters, for example, may also be employed.

In some applications of the method of the disclosure, the additives may be employed to lower the softening point of bitumen. The softening point of a bitumen may be determined by a test method wherein two horizontal disks of bitumen, cast in shouldered brass rings, are heated at a controlled rate in a liquid bath while each supports a steel ball. The softening point is reported as the mean of the temperatures at which the two disks soften enough to allow each ball, enveloped in bitumen, to fall a distance of 25 mm (1.0 inch). Generally speaking the additives of the disclosure may be employed to improve the properties of bitumen by: increasing serviceable temperature range; stiffening bitumen at high temperatures; softening bitumen at low temperatures; and improving flexibility at all temperatures.

Some of the components of the additives of the disclosure may have boiling points or vapor pressures that would cause those components to vaporize and be wasted if heated too quickly or under conditions that would not favor incorporation of those components into the bitumen. It follows then that when the bitumen is to be heated to a point near or above the boiling point of the additive component, the bitumen and additive are to be admixed first and then gradually heated to allow all, or as much as possible, of the additive component to be incorporated into the bitumen.

The additives of the disclosure advantageously exhibit a synergism. A shown below in the examples, the two components of the additive formulations coming together have a substantially greater impact on improving the physical properties of the modified bitumen than either component does when acting alone.

Embodiments of the methods of the application may be employed in any application where bitumen is being transported or moved and it would be desirable to avoid having to reheat the bitumen. For example, in one embodiment, bitumen is being transported in a rail or tank car and the rail car or tank begins to cool as soon as it is loaded. An additive of the invention is employed to lower the set up point sufficiently to allow the rail car or tank car to arrive at its destination before it has cooled to the set up point of the subject bitumen, thereby allowing the rail car or tank car to be off loaded without reheating. In another application, an additive of the invention is employed within a refinery to allow a bitumen that, unmodified, would be too viscous to move through a unit to be moved without the use of solvents or manual washouts. In still another embodiment, the additive is used to reduce the amount of energy necessary to pump a bitumen.

In addition to being a tool for determining whether or not a product bitumen admixture should be treated to mitigate instability, it may be desirable to use the method of the application to model the production process instead. In such embodiments, the materials to be used as bitumen feed streams are sampled prior to admixing them and then the samples are tested for ASI values. The samples are then admixed and the admixture tested for an ASI value. If the ASI value of the product stream is less than that of the average fees streams, then the streams can be admixed in different ratios or perhaps combined with different sources of bitumen.

### EXAMPLES

The following examples are provided to illustrate embodiments of the invention. The examples are not intended to limit the scope of the disclosure and they should not be so interpreted. Amounts are in w/v parts or w/v percentages unless otherwise indicated.

### Examples A-D and Control

A sample of unmodified bitumen is subjected to ASITSM testing and a control curve is generated and labeled “blank” in FIG. 1. Comparative Examples A and B show a resin and synergist run alone. Examples C and D show the substantial improvement in stability of the asphaltenes of the bitumen resulting from the combined materials as compared to both the blank and the individual components acting alone (which is proof of synergism).

Blank=Unmodified asphalt
Additive A=Alkyl-phenol resin

### Additive B=Synergist

Additive C=Alkyl-phenol resin+synergist
Additive D=Alkyl-phenol resin+synergist
All additives dosed at 0.5 wt %.

### Example E and Control

A sample of bitumen is mixed with an alkylphenol resin and imidazoline. A comparative control was prepared using the same bitumen and a conventional anti-strip additive. The two materials were stored at 280° F. and tested at 24 hours and 168 hours. Example E and the Control were admixed with gravel to form an aggregate and were then tested using the boiling water test. The object of the boiling water test is to determine the amount of bitumen remaining after the bitumen aggregate is exposed to boiling water. After 24 hours storage, the two materials performed equivalently. After 168 hours storage, Example E showed a retention of 40% more bitumen than the conventional anti-strip additive of the Control.

### Hypothetical Example 1

A sample of a virgin bitumen feed stream is tested using the BASIT and determine to have an index number of 12. A sample of a recycled bitumen feed stream is tested and determined to have an index number of 16. A product stream resulting from a 1:1 admixture of the two feed streams has an ASI index Value of 14.2. Since the product stream has an index value of 14.2 which is greater than the average for the feed streams, 14.0, no remedial action is employed.

### Hypothetical Example 2

Example 1 is repeated substantially identically except that product stream has an ASI index of 12.0. The product stream is treated with an additive prior to being sold.

### Hypothetical Example 3

Two holding tank of bitumen are tested for ASI index values. Samples of the two materials are then admixed at differing ratios until the ASI index value is about equivalent to a weighted average value for the feed streams.

What is claimed is:

1. A method for modifying bitumen comprising admixing unmodified bitumen with an additive to produce a modified bitumen wherein the modified bitumen has a physical property change, as compared to the unmodified bitumen and the physical property change is to a physical property selected from the group consisting of:
a set up point that is at least 2° C. lower than the unmodified bitumen;
an asphaltene stability that is improved such that asphaltenes are more resistant to precipitation during asphalt blending, gasoil blending, vacuum gasoil blending, storage and transport as compared to an unmodified bitumen;
an improved resistance to oxidative aging;
a more stable viscosity;
an improved adhesive strength wherein the modified bitumen has an adhesive strength that is at least 10 percent greater than unmodified bitumen; and
combinations thereof;
wherein the additive is prepared from a formulation comprising:
a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof; and
a second component which is a synergist and selected from the group consisting of polyamines, amidoamines, imidazolines, and combinations thereof.

2. The method of claim 1 wherein the additive is prepared including an (alkoxylated)-(di or tri)-alkyl phenol-aldehyde (amine) resin that has been alkoxylated using ethylene oxide.

3. The method of claim 1 wherein the synergist is a polyamine selected from the group consisting of polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

4. The method of claim 3 wherein the synergist is a quaternary ammonium salts of a polyamine selected from the group consisting of polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

5. The method of claim 1 wherein the synergist is an amidoamine and is a tall oil fatty acid amide prepared using a member selected from the group consisting of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

6. The method of claim 1 wherein the synergist is an imidazoline prepared using a tall oil fatty acid-amidoamine and a polyamine as detailed above and further substituted by forming alkyl esters, phosphate esters, thiophosphate esters, tetra-propenyl succinic anhydride (TPSA), dodecylsuccinic anhydride, amides/esters alkylphosphate esters, arylphosphate esters along the backbone.

7. A method of preparing bitumen comprising:
mixing at least two bitumen feed streams to prepare a bitumen product stream;
analyzing the feed streams and the product stream to determine a stability index value for each using a Bitumen Asphaltene Stability Index Test; and
when the index value for the bitumen product stream is less than about 90% of the weighted average index value for the feed streams, modifying the product stream to achieve a stability index value that is at least 90% of the weighted average index value for the feed streams.

8. The method of claim 7 wherein the modifying of the product stream is accomplished by employing a stabilizing additive.

9. The method of claim 8 wherein the stabilizing additive is wherein the additive is prepared from a formulation comprising:
a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof; and
a second component which is a synergist and selected from the group consisting of polyamines, amidoamines, imidazolines, and combinations thereof.

10. The method of claim 9 wherein the additive is prepared including an (alkoxylated)-(di or tri)-alkyl phenol-aldehyde (amine) resin that has been alkoxylated using ethylene oxide.

11. The method of claim 9 wherein the synergist is a polyamine selected from the group consisting of polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

12. The method of claim 11 wherein the synergist is a quaternary ammonium salts of a polyamine selected from the group consisting of polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

13. The method of claim 9 wherein the synergist is an amidoamine and is a tall oil fatty acid amide prepared using a member selected from the group consisting of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

14. The method of claim 9 wherein the synergist is an imidazoline prepared using a tall oil fatty acid-amidoamine and a polyamine as detailed above and further substituted by forming alkyl esters, phosphate esters, thiophosphate esters, tetra-propenyl succinic anhydride (TPSA), dodecylsuccinic anhydride, amides/esters alkylphosphate esters, arylphosphate esters along the backbone.

15. A method of preparing bitumen comprising:
modeling a bitumen production process by admixing samples of at least two bitumen feed streams to produce a model bitumen product stream;
analyzing the feed streams and the product stream to determine a stability index value for each using a Bitumen Asphaltene Stability Index Test; and
when the index value for the bitumen product stream is less than about 90% of the weighted average index value for the feed streams, repeat the process using different feed mix ratios and/or bitumen stability additives until a stable bitumen product stream model is produced; and
then using the model to control the bitumen production process.

16. The method of claim 15 wherein the bitumen stability additive is prepared from a formulation comprising:
a first component selected from the group consisting of (alkoxylated)-(di or tri)-alkyl phenol-aldehyde (amine) resins; α-Olefin-maleic anhydride co-polymers and grafted polymers including half ester/amide and full ester/amide derivatives; and combinations thereof; and
a second component which is a synergist and selected from the group consisting of polyamines, amidoamines, imidazolines, and combinations thereof.

17. The method of claim 16 wherein the additive is prepared including an (alkoxylated)-(di or tri)-alkyl phenol-aldehyde (amine) resin that has been alkoxylated using ethylene oxide.

18. The method of claim 16 wherein the synergist is a polyamine selected from the group consisting of polymers of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

19. The method of claim 16 wherein the synergist is an amidoamine and is a tall oil fatty acid amide prepared using a member selected from the group consisting of ethylene diamine, triethylene tetra-amine, tributyl tetra-amine, tetraethyl penta-amine, pentaethyl hexa-amine, hexaethyl hepta-amine, heptaethyl octa-amine, bis-hexamethytriamine, and mixtures thereof.

20. The method of claim 16 wherein the synergist is an imidazoline prepared using a tall oil fatty acid-amidoamine and a polyamine as detailed above and further substituted by forming alkyl esters, phosphate esters, thiophosphate esters, tetra-propenyl succinic anhydride (TPSA), dodecylsuccinic anhydride, amides/esters alkylphosphate esters, arylphosphate esters along the backbone.
